(19) United States
(12) Patent Application Publication
(10) Pub. No.: US 2002/0184355 A1
(43) Pub. Date: Dec. 5, 2002

(54) Method and system for reporting event data to requesting subscribers

(76) Inventor: Kevin A. Deats, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/873,689

(22) Filed: Jun. 4, 2001

(51) Int. Cl. G06F 15/173; G06F 15/16

(52) U.S. Cl. 709/223; 709/217

(57) ABSTRACT

A method for reporting event data to requesting subscribers using a manufacturing repository for collecting event data that is connected to a subscriber profile system for storing information relating to subscribers and a production system for storing information relating to manufacturing, which includes the step of gathering event data from a plurality of devices connected to the manufacturing repository, saving the event data to a database, notifying designated subscribers according to criteria indicated by subscriber profiles, and generating selectively subscription reports according to criteria indicated by subscriber profiles.

The present invention generally relates to an improved method and system for reporting event data to requesting subscribers. More specifically, it relates to an improved method and system for reporting event data to requesting subscribers using a manufacturing repository for collecting event data that is connected to a subscriber profile system for storing information relating to subscribers and a production system for storing information relating to manufacturing.

### BACKGROUND OF THE INVENTION

Event data, such as printer machine language (“PML”), is currently gathered only when there are operating malfunctions on the peripheral devices. Event data includes information for significant occurrences or happenings (e.g., paper jams, low memory, or undefined paper size) of a peripheral device. Aside from the event data being useful to service technicians trying to resolve a malfunction, the event data can also be extremely valuable for research and development, manufacturing and marketing.

Because of Internet communications, most peripheral devices are now embedded with a server, such as a web server. As a result, this event data can be downloaded by connected devices over the Internet. Currently, event data can already be downloaded via emails, which is disclosed in a commonly owned U.S. Patent application filed on ______ entitled “E-Mail-Based Remote Diagnostic Facility” bearing Ser. No. ______ by James E. Obert, Letty B. Nutt, William A. Cox, James M. Sangroniz, and Charles K. Keyes, assigned to HP company. This patent application is specifically incorporated by reference herein.

Since such event data may be of great interest for multiple departments, it would be advantageous to track the data and send it to various groups or dependent. Consequently, there is a need for an improved system that can take advantage of gathering this valuable information and routing it to various groups and persons in the company.

### BRIEF SUMMARY OF THE INVENTION

The present invention is directed to an improved method and system for reporting event data to requesting subscribers. More specifically, it relates to an improved method and system for reporting event data to requesting subscribers using a manufacturing repository for collecting event data, which is connected to a subscriber profile system for storing information relating to subscribers and a production system for storing information relating to manufacturing.

The present invention provides a method that includes the steps of gathering event data from a plurality of devices connected to the manufacturing repository, saving the event data to a database, notifying designated subscribers according to criteria indicated by subscriber profiles, and generating a scheduled subscription report according to criteria indicated by subscriber profiles independently of the foregoing steps.

### DESCRIPTION OF THE DRAWINGS

FIG. 1 is a schematic diagram of a network system in which the present method is implemented;

FIG. 2 is an overall schematic diagram of the preferred monitoring criteria of the manufacturing repository;

FIG. 3 is an overall schematic diagram of the manufacturing repository in relation to other systems;

FIG. 4 illustrates an example of one of the web pages for setting up the subscriber profile;

FIG. 5 is a flow chart illustrating the preferred functionality of a set up method of the subscriber profile system;

FIG. 6 is a flow chart illustrating the preferred functionality of a receive method of the manufacturing repository; and,

FIG. 7 is a flow chart illustrating the preferred functionality of a report method of the manufacturing repository.

### GLOSSARY OF TERMS AND ACRONYMS

The following terms and acronyms are used throughout the detailed description:

Event Data. Data relating significant occurrences or happenings of a peripheral device, which includes events such as paper jams, low memory, or undefined paper size.

Production system. A system for gathering and storing information relating to manufacturing.

Java Virtual Machine Design System. A system for gathering and storing information relating to Java Virtual Machine designs and diagnostics.

Manufacturing Repository (“MREP”). A system for, among other things, collecting event data for reports that are to be routed to the subscribers.

Remote Diagnostic Device System. A system for gathering and storing servicing information as described in the aforementioned Obert, et. al. application that has been incorporated by reference.

Subscriber Profile System. A system for gathering and storing information relating to the subscribers.

### DETAILED DESCRIPTION

Broadly stated, the present invention is directed to an improved method and system for reporting event data to requesting subscribers. The method and system provides a way to report event data to requesting subscribers by using a manufacturing repository (“MREP”) that is configured to gather event data from multiple connected devices, which data is saved to a database. Also, the requesting subscribers, according to criteria indicated by subscriber profiles, are notified of event data meeting the criteria. Furthermore, scheduled subscription reports are independently generated according to criteria indicated by the subscriber profiles. It should be understood that the use of “a” or “an” is also intended to mean “one or more” for better readability.

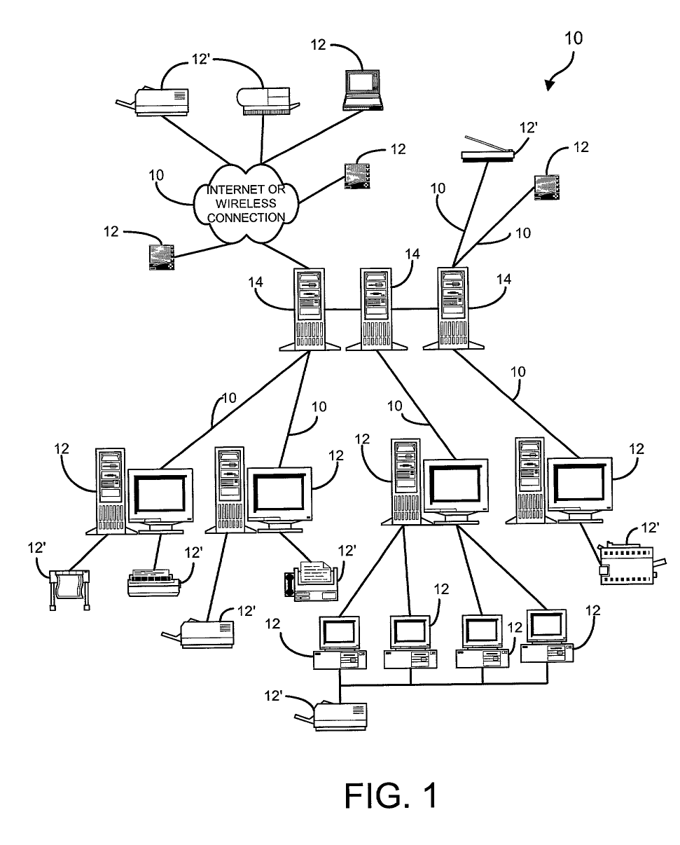

Turning now to the drawings, and particularly FIG. 1, a schematic diagram of a network system in which the present method is implemented is generally indicated as part of a preferably wide area network 10. A plurality of devices 12, 12′ are connected to the manufacturing repository (“MREP”) 14, which is provided by a plurality of computers as shown. It should be noted that a general device will be referred to in order to indicate that the preferred embodiment of the present invention can be implemented on a computing device 12 or a peripheral device 12′. Furthermore, the computing device 12 may be a computer, a microprocessor or other processing means such as an Application Specific Integrated Circuit (“ASIC”) or like, that is collecting data from multiple peripheral devices 12′. The devices are preferably implemented with the use of a web server, since the preferred network connection 10 is the Internet. So, the peripheral devices 12′ preferably include embedded web servers, and the computing devices 12 similarly include ways of connecting to the Internet. Furthermore, the computing device 12 may be a computer that is collecting data from multiple peripheral devices 12′.

The Internet is the preferable network connection 10 because it provides a very flexible and universal way of communicating. The accessibility of the Internet from almost any location in the world is a very desirable aspect and is important to the scale of utilization of the present invention. However, other types of networks can certainly be used in conjunction with the Internet or even in place of it. Because the network system needed for the implementation of the present invention varies greatly in complexity and size, an explanation of the current preferred embodiment of the network topology is given as an example. Other network systems for implementing the present invention are contemplated and are within the scope of the present invention.

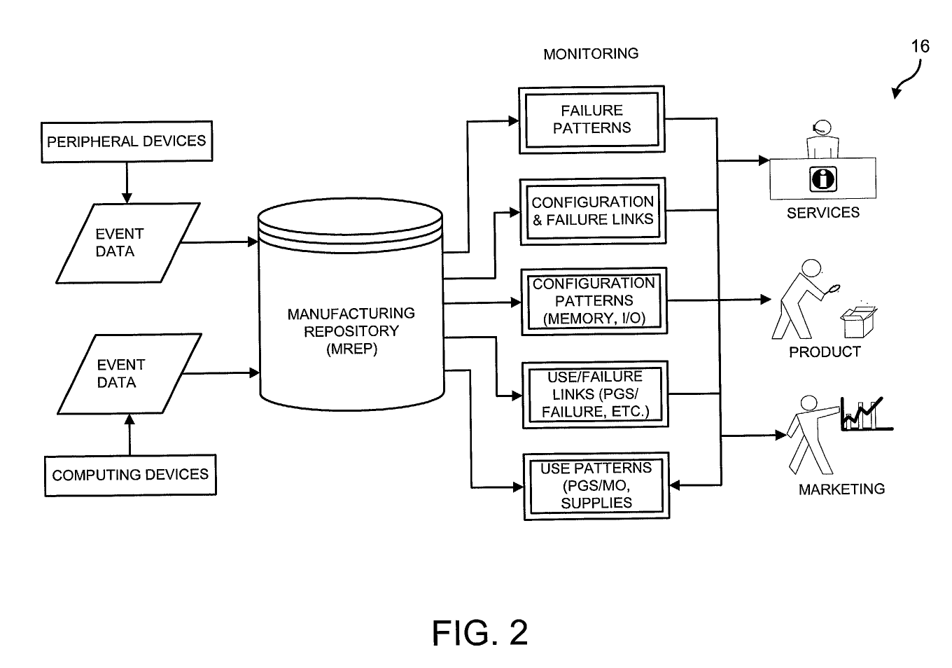

An overall schematic diagram of the preferred monitoring criteria of the MREP is shown in FIG. 2 and indicated generally at 16, which is an example of the type of information that can be gathered and used. The MREP gathers the event data from peripheral devices or computing devices, and in turn monitors various configurations and occurrences of a given model or a given location. These monitoring criteria can include, among other things, failure patterns, configuration and failure links, configuration patterns, use and failure links, and use patterns. All of this valuable data can be grouped and sent to various groups and persons for improving such things as services, product and marketing. The event data, on the other hand, preferably includes data relating to information, such as region, manufacture, model and/or customer identification. But, of course, the data can include more or less of than this particular information. The information content of the event data may be different depending on the chosen implementation of the present invention, and such other variations are within the scope of the present invention.

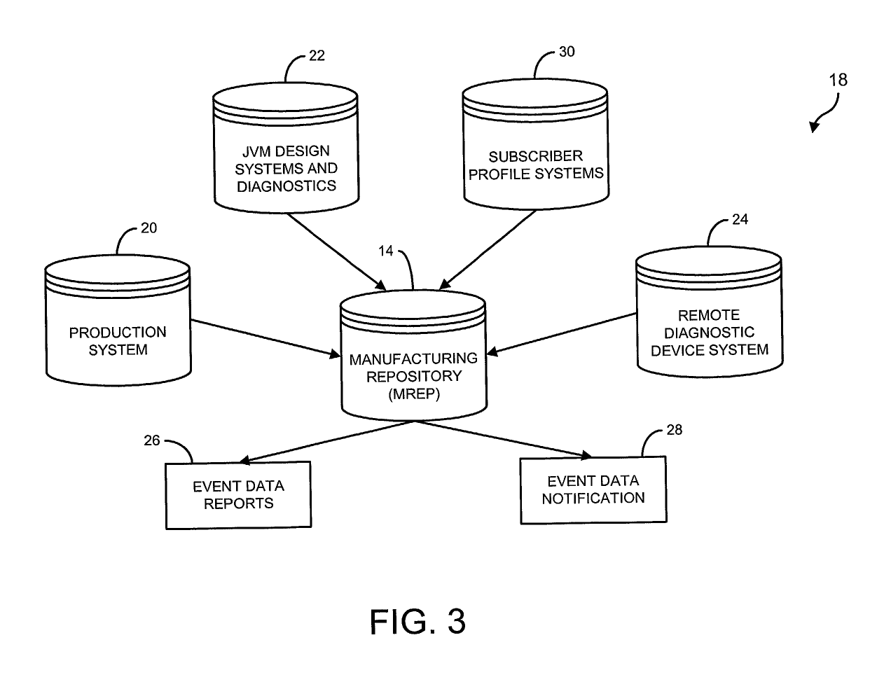

An overall schematic diagram of the manufacturing repository in relation to other systems is shown in FIG. 3, and indicated generally at 18. The MREP 14 is preferably connected to multiple systems that gather various data to be stored preferably on a central database. One system is a production system 20, which stores data relating to manufacturing. Another system is a Java Virtual Machine (“JVM”) Design system 22, which gathers and stores data relating to the JVM designs and diagnostics. There is also a remote diagnostic device system 24 that gathers and stores servicing information as described in the aforementioned Obert, et. al. patent application. All these systems focus on gathering the event data for the MREP to generate event reports 26 and event notifications 28. The subscriber profile system, in contrast, stores users' information. Using the subscriber profile system, users can set up or edit their subscriber profile preferably by using a web page on the Internet.

Although multiple systems are used and shown, the present invention can also be implemented with just the MREP having some or all of these systems. For example, the MREP can gather the event data and subscriber profiles with no other systems connected to it. However, since some of these systems described have already been implemented, the preferred embodiment is customized to work with previously systems that are already in place. These various implementations of the present invention can be included, and they are to be considered within the scope of the present invention.

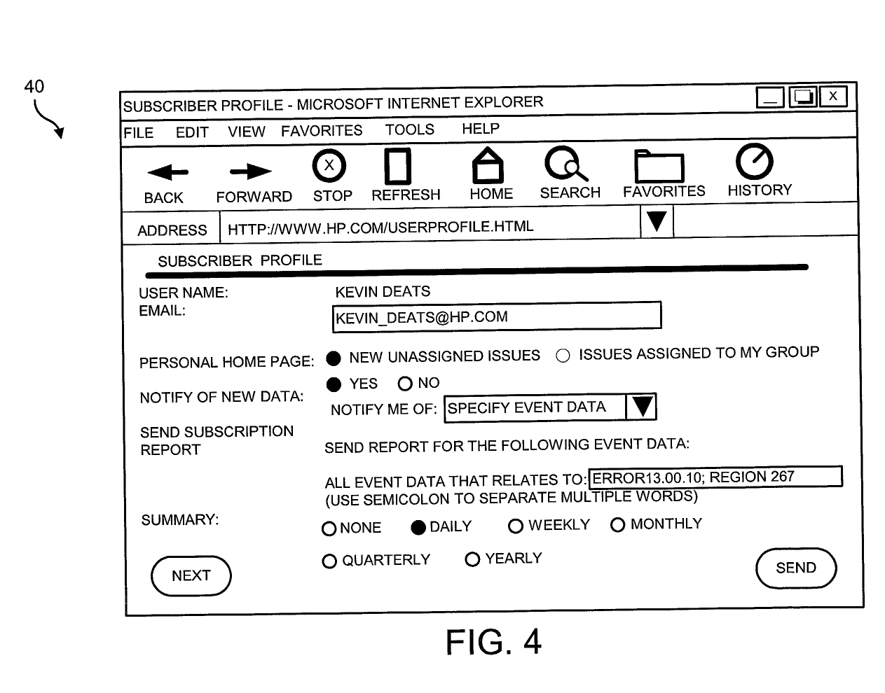

An example of one of the web pages for setting up the subscriber profile is shown in FIG. 4, and indicated generally at 40. In this example, there are multiple fields shown. The user name, email and personal home page fields are description relating to the subscriber identity. The remaining fields, specifically “notify of new data” and “send subscription report,” relates to the kinds of notifications and subscription reports that the subscriber can request.

Subscribers, using the “specify event data” field, can indicate the kind of event data that an automatic notification should be sent to them whenever the MREP receives such event data. The subscriber may have inserted several entries in the specify event data field, such as patterns, configuration and link failure, configuration patterns, use or failure links, and use patterns, among other types of event data. These are preferably made by selecting one or more items that have been predefined and placed in the field for subscriber selections. This eliminates the possibility of excluding items that would not be found during a search because a subscriber used language that was different from a normal or expected description of an item. However, the system may also permit the use of subscriber defined key words, if desired.

On the other hand, the “send subscription report” includes fields that define the criteria of the subscription reports. For example, in the field, “all event data that relates to,” subscribers can indicate an error code number (e.g., error 13.00.10) and/or a region number (e.g., region 267) criteria for the subscription reports. In other words, a report will be generated, for example, to indicate the frequency of error code number 13.00.10 at region 267. The region criteria is especially helpful, because a technician will be able to track the kinds of errors that a particular manufacture is producing. For example, if printers that are produced in Mexico show a pattern of having a high frequency of paper jams error, product inspection personnel can isolate the problems with greater focus and precision. With this kind of valuable information, the manufacturers can quickly resolve these production problems. Subscribers can also choose a time cycle, such as none, daily, weekly, monthly, quarterly or yearly, for when they should receive these reports.

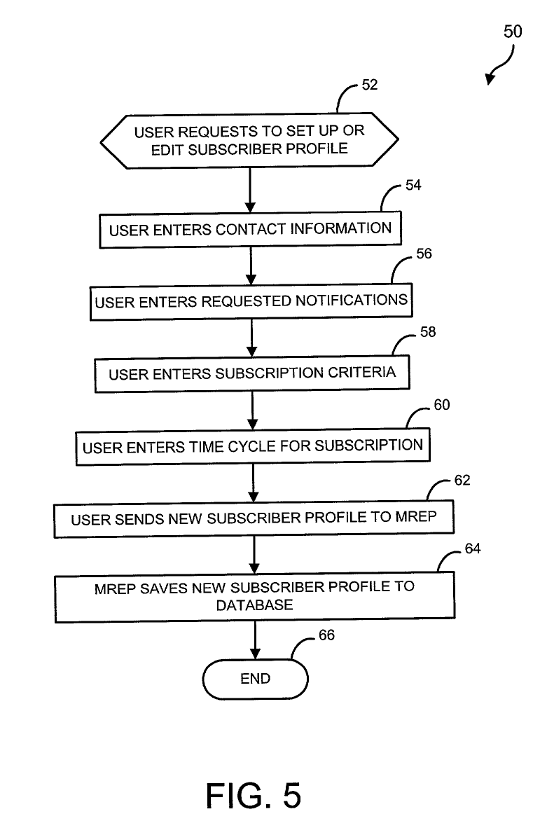

Turning to an important aspect of the preferred embodiment of the present invention, a flow chart of the preferred functionality of a method to set up or edit subscriber profiles of the subscriber profile system is shown in FIG. 5, and indicated generally at 50. The set up method is initiated by a user requesting to set up or edit a subscriber profile (block 52) through preferably a web page on the Internet (shown in FIG. 4). As shown in FIGS. 4 and 5, the user must enter various information, such as contact information (block 54), requested notification (block 56), subscription criteria (block 58), and a time cycle of the subscription (Block 60). Upon the user's completion with the entering of the new subscriber profile, the user sends it to the MREP (block 62), which is, in turn, saved to the database of the MREP (block 64). The set up process ends after the last step (block 66).

Because the parameters of the subscriber profile can be varied, it should be understood that the method shown in FIG. 5 can be changed. Although the preferred method and parameters have been shown, it is very likely it will be altered depending on the implementation of the present invention. The current parameters of the subscription report may include text, tables, charts and graphs, as well as other forms of information. Thus, it should be noted that these other parameters and methods are contemplated, and they are within the scope of the present invention.

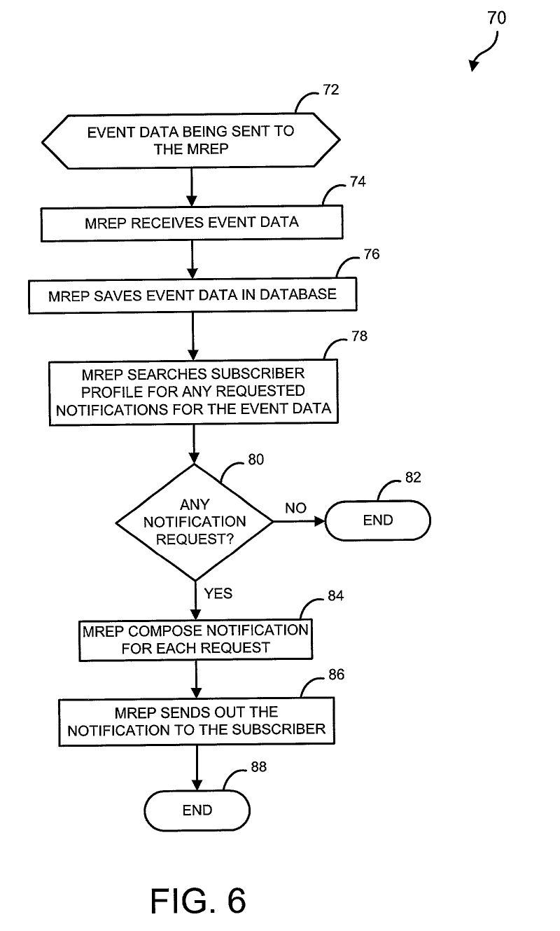

A flow chart of the preferred functionality of a method for receiving event data by the MREP is shown in FIG. 6, and indicated generally at 70. The receive method is initialized by event data being sent to the MREP (block 72). After the MREP receives the event data (block 74), it saves the event data in the database (block 76). The MREP next searches the subscriber profile system for any requested notifications for the event data (block 78). It is then determined whether there is any requested notifications that are due (block 80). If not, the process ends from this point on (block 82). Otherwise, the process continues by composing a notification for each request that needs to be sent (block 84). The MREP then sends the composed notifications to the designated subscribers (block 86), and ends the process (block 88).

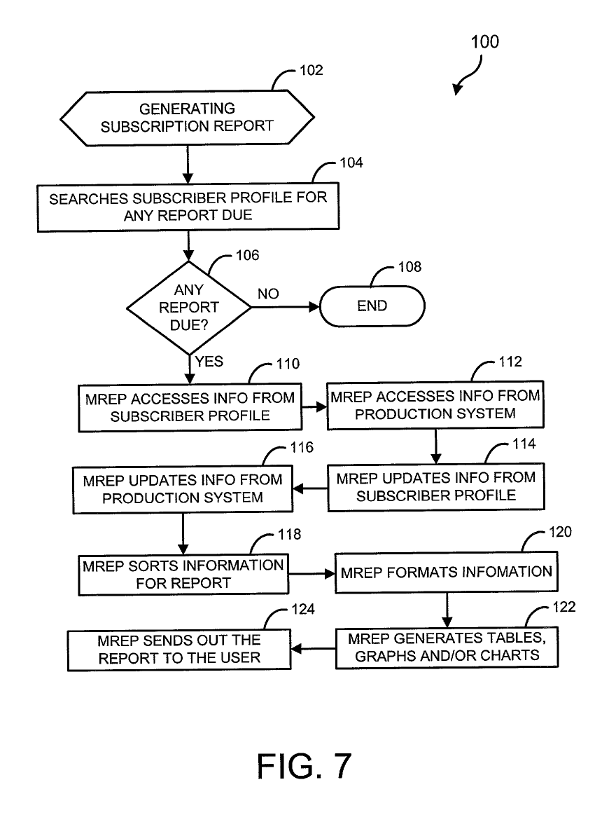

A flow chart illustrating the preferred functionality of a method for generating report is shown in FIG. 7, and indicated generally at 100. The report method is initialized by an indication to the MREP that subscription reports need to be generated (block 102). The indication is preferably prompted by a predetermined time schedule, such as daily or weekly as specified by the web page choices shown in FIG. 4. However, other ways, such as a predefined event can be used, and these other implementations are within the scope of the present invention. The subscriber profile system is then searched by the MREP (block 104) to determine whether any subscription report is due at this time (block 106). If no subscription report is due (block 106), the process ends (Block 108). If, however, a subscription report is due (block 106), the MREP accesses the needed information to generate the subscription report from the subscriber profile system (Block 110) and the production system (block 112).

Next, the subscriber profile system (block 114) and the production system (block 116) are updated to reflect that a report is being generated. To generate the subscription report, the MREP sorts the information obtained (block 118), and formats the information according to criteria indicated by the subscriber's profile (block 120). Depending on the requested format of the subscription report and the criteria of the subscriber profile, the MREP can further generate a table, a chart and/or a graph for the subscription report (block 122). Once the subscription report is composed, the MREP sends out the report according to the criteria indicated by the subscriber profile (block 124).

From the foregoing description, it should be understood that an improved method and system for reporting event data to requesting subscribers has been shown and described, which has many desirable attributes and advantages. The method and system that can automatically track and sent various event data to multiple relevant groups, which can be of great importance to different departments in a company.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

What is claimed is:

1. A method for reporting event data to requesting subscribers using a manufacturing repository for collecting event data that is connected to a subscriber profile system for storing information relating to subscribers and a production system for storing information relating to manufacturing, comprising the steps of:
gathering event data from a plurality of devices connected to the manufacturing repository;
saving the event data to a database;
notifying designated subscribers according to criteria indicated by subscriber profiles; and,
generating selectively subscription reports according to criteria indicated by subscriber profiles.

2. The method according to claim 1 wherein the event data further comprises information relating to any one from the group of region, manufacture, model or customer identification.

3. The method according to claim 1 wherein the subscription report comprises information in the form of text, tables, charts and/or graphs.

4. The method according to claim 1 further comprising the step of sending the subscription report to a requesting subscriber.

5. The method according to claim 1 further comprising the steps:
requesting to set up or change a subscriber profile;
entering new subscriber information to a subscriber profile; and,
saving the new subscriber profile to the manufacturing repository.

6. The method according to claim 5 wherein said step of entering new subscriber information further comprising the steps of:
entering contact information of the subscriber;
entering subscriber's desired notification request;
entering subscription report criteria; and,
entering designated time cycle for subscription report.

7. The method according to claim 6 wherein the time cycle includes any one from the group of none, daily, weekly, monthly, quarterly or yearly.

8. The method according to claim 5 wherein, prior to said step of saving new subscriber profile, further comprising the steps of:
sending the new subscriber profile to the manufacturing repository; and,
receiving the new subscriber profile by the manufacturing repository.

9. The method according to claim 1 wherein, prior to said step of gathering event data, further comprising the steps of:
sending the event data to the manufacturing repository; and,
receiving the event data by the manufacturing repository.

10. The method according to claim 1 wherein said step of notifying designated subscribers further comprising the steps of:
searching the subscriber profile for notification requests for the event data according to the requested criteria;
determining whether there is any notification requests for the event data;
composing notifications for each notification request determined in the subscriber profile; and,
sending out the notifications to the requesting subscriber.

11. The method according to claim 10 further comprising the step of idling until the manufacturing repository receives the event data.

12. The method according to claim 10 wherein the indicated criteria includes any one from the group of event occurrence by page count, event occurrence by region, event occurrence by manufacturing information, event occurrence by device model, or event occurrence by customer.

13. The method according to claim 1 wherein said step of generating scheduled subscription reports further comprising the steps of:
searching the subscriber profile for any scheduled subscription report due;
determining whether there is any scheduled subscription report due; and,
accessing information relating to the subscriber of any predetermined scheduled subscription report due.

14. The method according to claim 13 further comprising the step of updating information from the subscriber profile.

15. The method according to claim 13 further comprising the steps of:
accessing the information relating to the manufacturing from the production system; and,
updating information from the production system.

16. The method according to claim 13 further comprising the steps of:
sorting the information for the scheduled subscription report according to the criteria of the requesting subscriber profile; and,
formatting the information to generate the report.

17. A computer program product comprising a computer usable medium having computer readable program codes embodied in the medium that when executed causes a computer to:
gather event data from a plurality of devices connected to a manufacturing repository;
save the event data to a database;
notify designated subscribers according to criteria indicated by subscriber profiles; and,
generate selectively subscription reports according to criteria indicated by subscriber profiles.
